(19) United States
(12) Patent Application Publication
(10) Pub. No.: US 2010/0231451 A1
(43) Pub. Date: Sep. 16, 2010

(54) ANTENNA DEVICE

(75) Inventors: Wataru Noguchi, Hyogo (JP); Hiroyuki Yurugi, Osaka (JP); Sotaro Shinkai, Osaka (JP); Akihiko Shiotsuki, Osaka (JP); Toshihiro Ezaki, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/446,702

(22) PCT Filed: Oct. 23, 2007
(86) PCT No.: PCT/JP2007/070634

§ 371 Date: Apr. 22, 2009

(30) Foreign Application Priority Data
Oct. 23, 2006 (JP) 2006-287791

(51) Int. Cl. H01Q 3/44; H01Q 9/16

(52) U.S. Cl. 342/367; 343/793

(57) ABSTRACT

An antenna device has a linear antenna element; a passive element section provided in proximity to the antenna element; and a control section that controls the passive element section. The passive element section has a linear line laid in parallel to the antenna element; and an impedance adjustment section that adjusts impedance of the passive element section. A compact antenna device capable of switching its directivity by means of electrical operation can be provided.

### TECHNICAL FIELD

The present invention relates to an antenna device whose directivity is switched.

### BACKGROUND ART

The following two factors are primarily responsible for unstable wireless communication. The first factor is a failure to acquire sufficient receiving electric field intensity because of a distance between wireless devices that is too long in relation to an output of an electric wave. In the case of this problem, an antenna of at least one of the two wireless devices is provided with directivity, and main probes of the devices are oriented to each other. Consequently, the wireless devices can receive a radio wave at sufficient, stable electric field intensity.

The second factor is fading that arises from interference caused by waves reflected from walls, a ceiling, and the like. This problem noticeably arises at a location where no substantial intensity difference exists between a direct wave and a reflected wave of a radio wave. Even in the case of this problem, an antenna of a receiver is provided with directivity, and the main probe of the receiver is directed toward a desired wave, and directivity is set so as to exhibit a null point in the other directions. As a consequence, the receiver does not receive radio waves other than the desired wave, so that interference can be prevented.

The solution is appropriate, so long as a wireless communication scheme is an SISO (Single Input Single Output) method, and there is adopted a diversity in which a receiver simply selects one from a plurality of antennas. However, when two respective antennas of a receiver have directivity; when one antenna receives a direct wave; and when the other antenna receives an indirect wave, the following problems arise. Namely, when the indirect wave is longer than the direct wave in terms of a delay time as compared with an assumed guard interval time, the indirect wave acts as the source of interference; hence, demodulation cannot be performed by means of a simple configuration in which the receiver uses only an OFDM modulation scheme.

Patent Document 1: JP-T-2006-506899

Patent Document 2: U.S. Published Patent Application No. 2004-0098745

Patent Document 3: WO2004/047373

### DISCLOSURE OF THE INVENTION

### Problem that the Invention is to solve

According to a MIMO (Multi Input Multi Output) scheme adopted for IEEE802.11n that is one of the wireless LAN standards, a receiver receives a radio wave with a plurality of antennas and produces one propagation path by active utilization of a path difference between the radio waves. A wireless device used in a wireless communication system adopting the MIMO scheme has an antenna device having a plurality of nondirective antennas, such as dipole antennas and sleeve antennas. However, correlation between antennas becomes greater without conceiving a contrivance, such as assurance of a sufficient interval between antennas and a combination of different polarized waves by tilting the respective antennas in different directions, which in turn deteriorates transmission quality. For these reasons, the antenna device of the wireless device compliant with the MIMO scheme cannot be made compact.

An IFE (In-Flight Entertainment) system that distributes movies, music, games, and the like, to passenger terminals in a passenger cabin of an aircraft, and the like, has been known. The IFE system primarily has a server and client terminals (SEB: seat entertainment BOX). A form for wirelessly transmitting information from a server to client terminals by way of WAP (Wireless Access Points) as well as a form for establishing communication by connecting a server to client terminals by way of wires are conceivable as a communication scheme for the IFE system. Since the passenger cabin of the aircraft is a space enclosed by metal, such as aluminum, there are many high-level waves reflected from a ceiling, walls, and a floor. Since the MIMO scheme actively utilizes reflected waves as mentioned above, the scheme is considered to be a scheme effective in such a radio wave environment. Moreover, the client terminals can efficiently receive reflected waves, so long as a plurality of antennas provided in the respective client terminals are provided with different directivities.

However, the client terminals are principally disposed in the neighborhoods of passenger seats and hence cannot be made bulky. For this reason, when the communication scheme of the IFE system is wireless, the antenna device provided in the client terminal must be compact. Further, a radio wave environment for a position where the client terminal is to be disposed is various. For these reasons, it is desirable that the directivity of the antenna device be switched by electrical operation.

An object of the present invention is to provide a compact antenna device capable of switching directivity by means of electrical operation.

### Means for Solving the Problem

The present invention provides an antenna device comprising a linear antenna element; a passive element section provided in proximity to the antenna element; and a control section that controls the passive element section, wherein the passive element section includes a linear line arranged in parallel to the antenna element; and an impedance adjustment section that adjusts impedance of the passive element section.

In the antenna device, the impedance adjustment section is a diode electrically connected to the linear line.

In the antenna device, the passive element section is a dipole element in which two quarter-wave lines are arranged in a straight line; and the impedance adjustment section is a diode disposed at a center of the dipole element.

In the antenna device, the antenna element and the passive element section are provided in parallel to each other; and an electrical length from an end of the antenna element to the passive element section is a quarter wavelength.

In the antenna device, the passive element sections are respectively provided at both ends of the antenna element.

In the antenna device, the control section outputs a control signal for controlling the impedance adjustment section.

The antenna device further includes two inductor sections, one being provided in a wire connecting the passive element section to the control section, and the other being provided in a wire connecting the passive element section to a ground.

In the antenna device, the antenna element is a sleeve antenna or a dipole antenna.

### ADVANTAGE OF THE INVENTION

An antenna device of the present invention enables switching of its directivity by means of electrical operation. Moreover, since an electrical length from an antenna element to a passive element is merely a quarter wavelength, the antenna device can be made compact when the antenna device is used at a high frequency.

### BRIEF DESCRIPTION OF THE DRAWINGS

FIG. 1 A view showing an IFE system utilizing wireless communication.

FIG. 2 A block diagram showing an internal configuration pertaining to communication function of a client terminal.

FIG. 3 A top view showing a pattern of an antenna device.

FIG. 4 A perspective view showing the pattern of the antenna device.

FIG. 5 A circuit diagram showing a passive element.

FIG. 6 A view showing directivity of the antenna device shown in FIG. 4 achieved within a ZX plane when both passive elements are in an OFF position.

FIG. 7 A view showing the directivity of the antenna device shown in FIG. 4 achieved within an XY plane when both passive elements are in the OFF position.

FIG. 8 A view showing the directivity of the antenna device shown in FIG. 4 achieved within the ZX plane when one passive element is in an ON position and when the other passive element is in the OFF position.

FIG. 9 A view showing the directivity of the antenna device shown in FIG. 4 achieved within the XY plane when one passive element is in an ON position and when the other passive element is in the OFF position.

FIG. 10 A block diagram showing the internal configuration of a control section.

### DESCRIPTIONS OF THE REFERENCE NUMERALS

11 SERVER
12 CONNECTION CABLE
13 WAP
14 CLIENT TERMINAL
21 WIRELESS SECTION
23 ANTENNA SECTION
25 COAXIAL CABLE
31 ANTENNA DEVICE
33 CONTROL SECTION
43 SLEEVE ANTENNA
45a, 45b PASSIVE ELEMENT
51 QUARTER-WAVE LINE
53 PIN DIODE
55 CAPACITOR
57a, 57b WIRING
61 CHOKE COIL
81 POWER SOURCE SECTION
82 CONSTANT VOLTAGE GENERATION SECTION

### BEST MODE FOR IMPLEMENTING THE INVENTION

An embodiment of the present invention will be described hereunder by reference to the drawings.

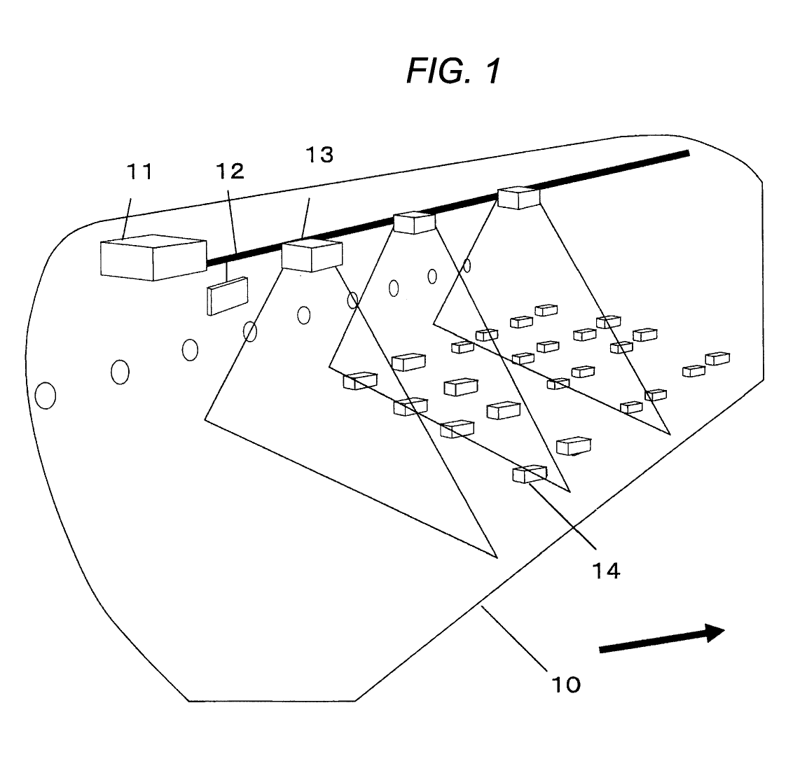

FIG. 1 is a view showing an IFE system utilizing wireless communication. An IFE (In-Flight Entertainment) system is a system that distributes movies, music, games, and the like, to passenger terminals, or the like, in a passenger cabin of an aircraft. As shown in FIG. 1, the IFE system has a server 11, a connection cable 12, a plurality of WAPs 13, and a plurality of client terminals 14. The server 11, the connection cable 12, and the plurality of WAPs 13 are disposed on a ceiling of a passenger cabin 10, and the server 11 and the WAPs 13 are connected together by way of the connection cable 12. The client terminals 14 are disposed in the vicinities of passenger chairs. The WAPs 13 and the client terminals 14 each have an unillustrated wireless network interface circuit and can establish wireless communication utilizing a wireless LAN complying with IEEE802.11n. Specifically, the WAPs 13 and the client terminals 14 perform wireless communication utilizing a MIMO (Multi Input Multi Output) scheme. Therefore, the WAPs 13 and the client terminals 14 utilize an array antenna having a plurality of antenna elements.

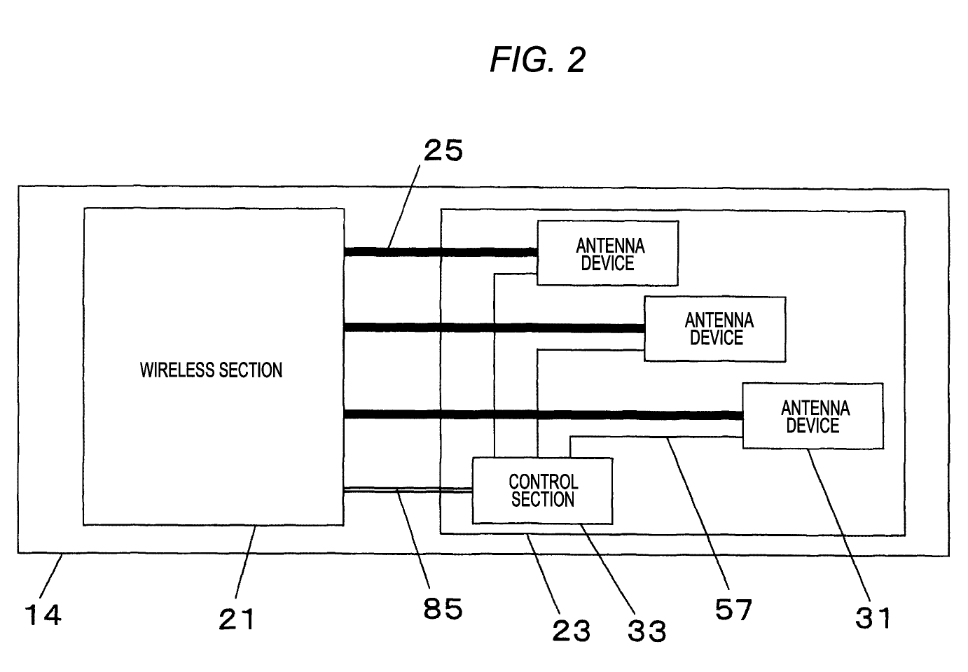

FIG. 2 is a block diagram showing an internal configuration pertaining to communication function of the client terminal 14. As shown in FIG. 2, the client terminal 14 has a wireless section 21 and an antenna section 23. The antenna section 23 has three antenna devices 31 and a control section 33. The respective antenna devices 31 are connected to the wireless section 21 by means of a coaxial cable 25. Further, the respective antenna devices 31 are controlled by an analogue control signal output from the control section 33.

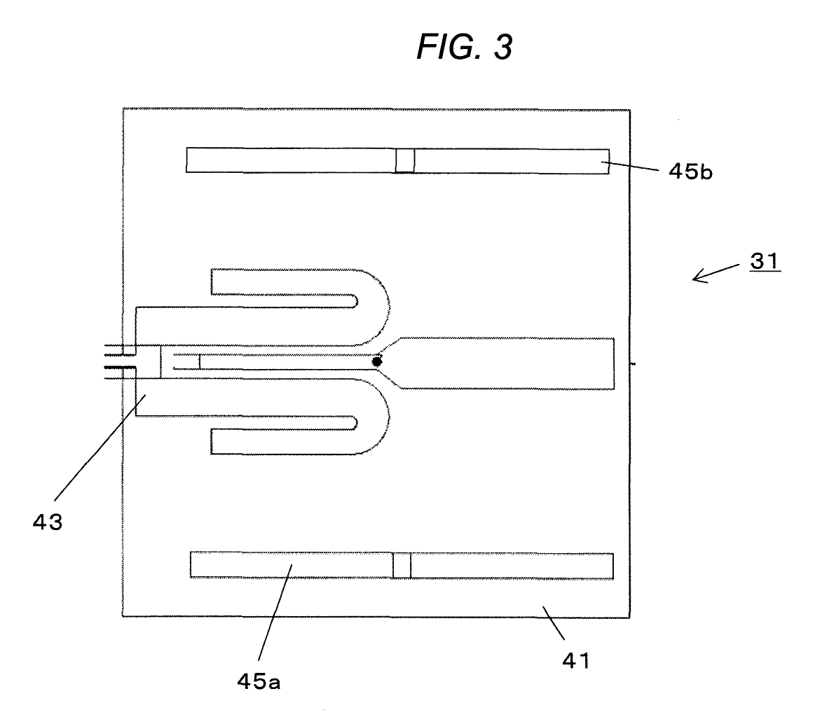

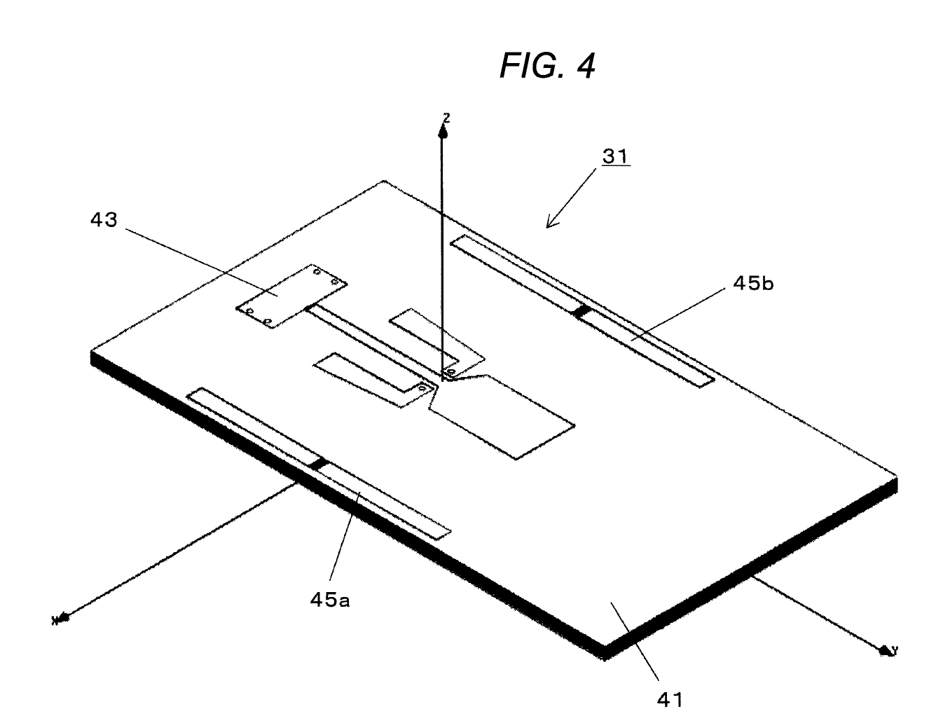

FIG. 3 is a top view showing a pattern of the antenna device 31. FIG. 4 is a perspective view showing the pattern of the antenna device 31. As shown in FIGS. 3 and 4, the antenna device 31 has a sleeve antenna 43 and two passive elements 45a and 45b that are provided on a substrate 41 which exhibits a dielectric constant of 10.5 at 5 GHz. Although not shown in FIGS. 3 and 4, the respective passive elements are connected to a wire connected to the control section 33 and a wire connected to the ground. The sleeve antenna 43 is connected to the wireless section 21 by means of the coaxial cable 25. The passive elements 45a and 45b are dipole antennas, each of which has a length equivalent to a half wavelength, and are not connected to the wireless section 21. The passive elements 45a and 45b are provided at respective ends of the sleeve antenna 43 in parallel to the sleeve antenna 43. An electrical length from the end of the sleeve antenna 43 to the centers of the respective passive elements 45a and 45b are about a quarter wavelength; for instance, 9.5 mm.

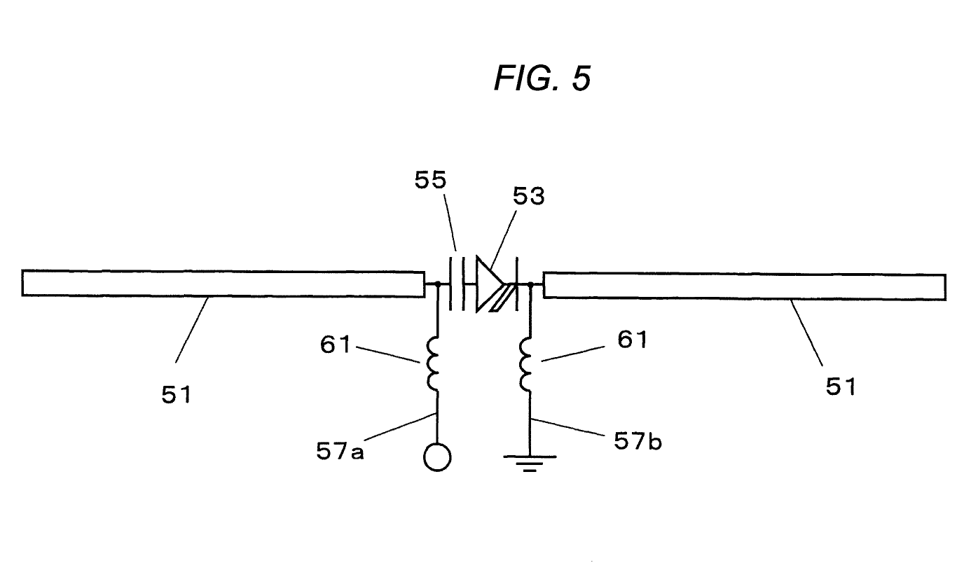

FIG. 5 is a circuit diagram showing the passive elements 45a and 45b. As shown in FIG. 5, each of the passive elements 45a and 45b that are half-wave dipole antennas has two quarter-wave lines 51 provided in the form of a straight line, and a PIN diode 53 and a capacitor 55 provided in the middle between the two quarter-wave lines 51. Two wires 57a and 57b are connected across the PIN diode 53 and the capacitor 55; the wire 57a connected to the anode of the PIN diode 53 is connected to the control section 33; and the wire 57b connected to the cathode of the PIN diode 53 is connected to the ground. Therefore, the PIN diode 53 is brought into a forwardly-biased state or a reversely-biased state in accordance with an analogue control signal output from the control section 33. When the PIN diode is in the forwardly-biased state, the impedance of the diode is low, and the passive elements are brought into an ON position. In the meantime, when the diode is in the reversely-biased state, the impedance of the diode is high, and the passive elements are brought into an OFF position.

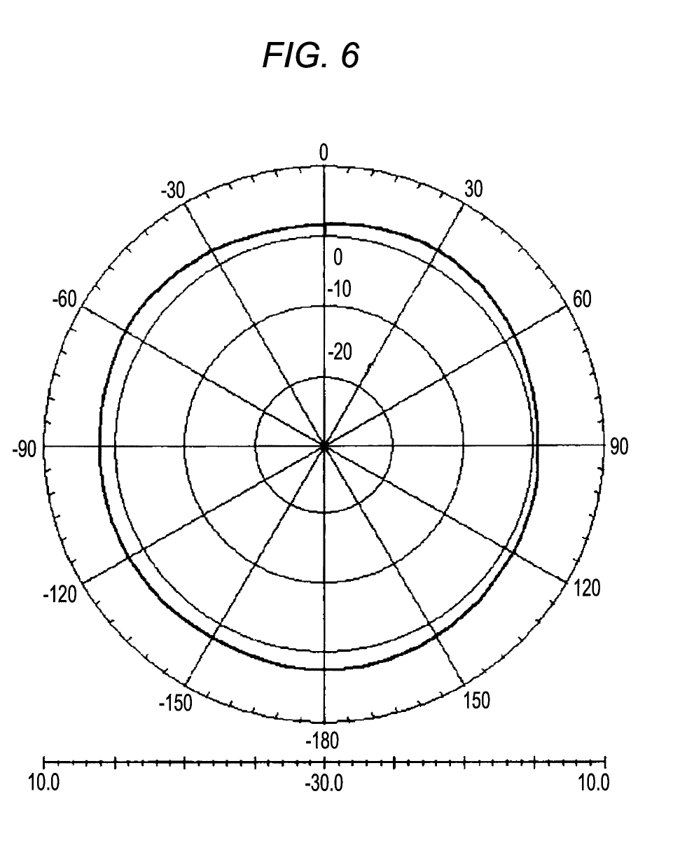

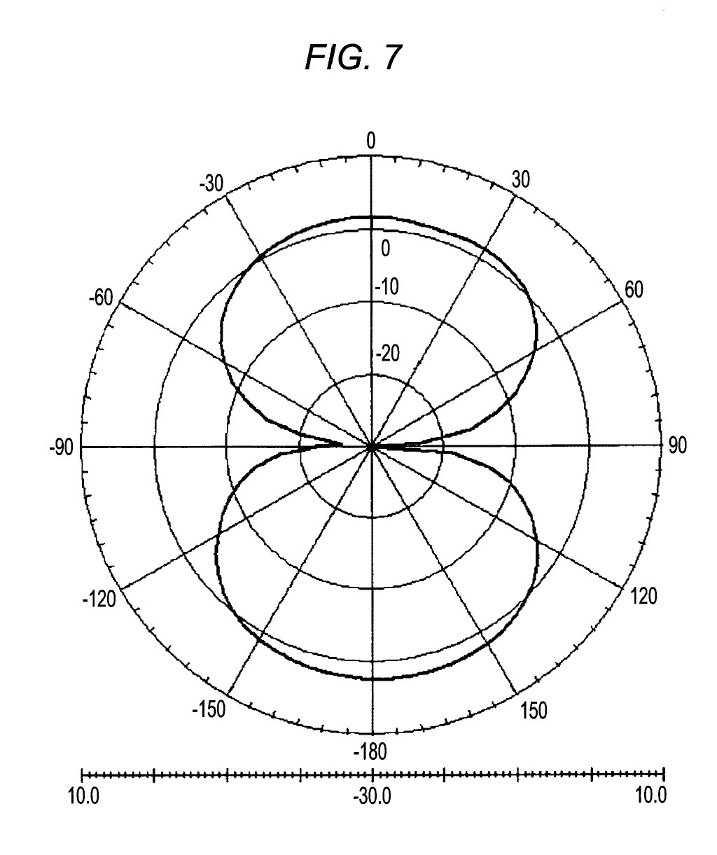

FIGS. 6 and 7 show directivity of the antenna device 31 achieved when both passive elements 45a and 45b are in the OFF position. FIG. 6 is a view showing directivity of the antenna device 31 shown in FIG. 4 achieved within a ZX plane, and FIG. 7 is a view showing the directivity of the antenna device 31 shown in FIG. 4 achieved within an XY plane. Since both the passive elements 45a and 45b are in the OFF positions, the directivity of the sleeve antenna 43 is shown. As shown in FIGS. 6 and 7, the antenna device 31 in this state exhibits omnidirectionality within the ZX plane, a curve exhibiting directivity within the XY plane assumes the shape of a figure eight extending in the direction of an X-axis.

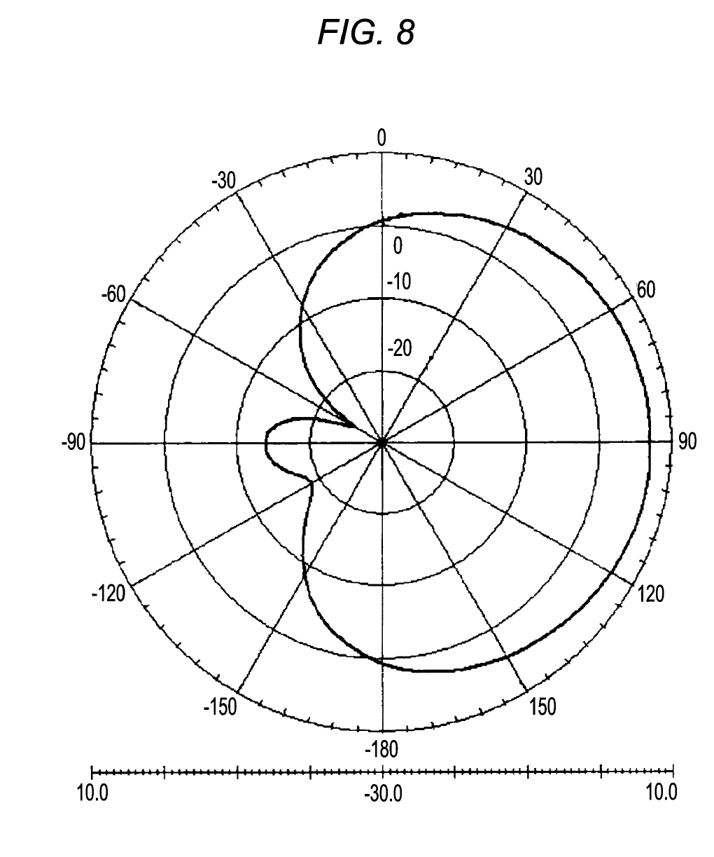

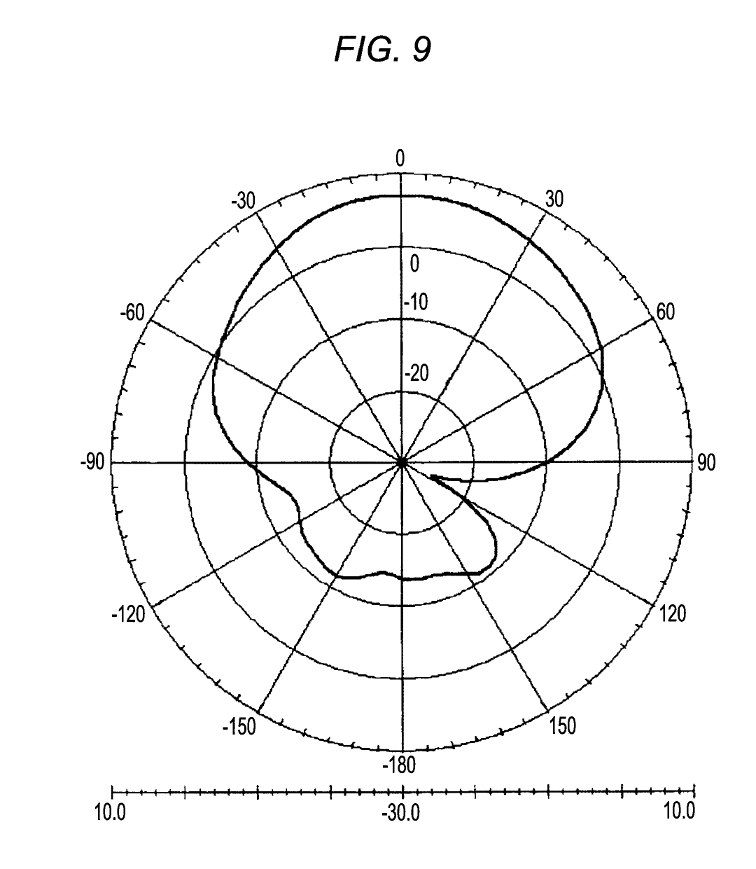

FIGS. 8 and 9 show directivity of the antenna device 31 achieved when passive element 45a is in the ON position and when the other passive element 45b is in the OFF position. FIG. 8 is a view showing directivity of the antenna device 31 shown in FIG. 4 within the ZX plane, and FIG. 9 is a view showing directivity of the antenna device 31 shown in FIG. 4 within the XY plane. As shown in FIGS. 8 and 9, the main probe is oriented toward only the passive element 45b remaining in the OFF position, and the directivity of the antenna device 31 achieved in this state shows a null point on the passive-element-45a side remaining in the ON position. The passive element 45a in the ON position performs secondary radiation according to the radio wave emitted from the sleeve antenna 43. The radio wave emitted from the sleeve antenna 43 and the radio wave secondary radiated from the passive element 45a overlap and cancel each other. Therefore, the directivity of the sleeve antenna 43 toward the passive element 45a exhibits a null point.

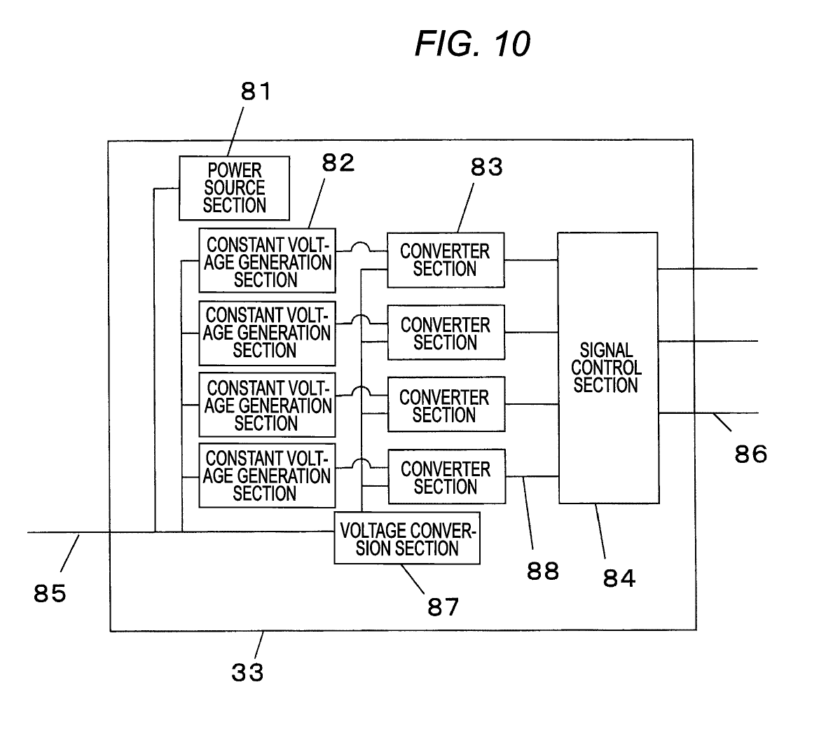

As mentioned above, the passive elements 45a and 45b are brought into the ON position or the OFF position, thereby enabling realization of four different directivities. As mentioned above, the states of the passive elements 45a and 45b are controlled by an analogue control signal output from the control section 33. FIG. 10 is a block diagram showing the internal configuration of the control, section 33. As shown in FIG. 10, the control section 33 has four constant voltage generation sections 82, a voltage conversion section 87, four converter sections 83, a signal control section 84, and a power source section 81. A control signal 85 is input from the wireless section 21 to the control section 33. In accordance with the control signal 85 from the wireless section 21, the constant voltage generation section 82 generates four types of voltages ranging from 1.75 to 2.50V at increments of 0.25 V, and applies the thus-generated voltages to the converter sections 83. The voltage conversion section 87 converts a voltage of the control signal 85 into a half voltage and inputs the half voltage to the four converter sections 83.

The converter section 83 compares the voltage applied from the constant voltage generation section 82 with the voltage applied from the voltage conversion section 87, and outputs a signal 88 conforming to a comparison result. The signal control section 84 outputs an analogue control signal 86 complying with the respective signals output from the four converter sections 83. The signal control section 84 stores a table showing a relationship between the respective signals output from the four converter sections 83 and the analogue control signal 86. The power source section 81 supplies power to the four constant voltage generation sections 82, the voltage conversion section 87, the four converter sections 83, and the signal control section 84.

The voltage of the analogue control signal 86 is any of voltages ranging from 3 to 5V at increments of 0.5V. When a plurality of types of voltages are required, the essential requirement is to make a step interval smaller than a value of 0.5V. Further, the signal output from the signal control section 84 is not limited to an analogue format and may also be a digital format, such as a serial output or a parallel output.

In the present embodiment, choke coils 61 are provided in the respective two wires 57a and 57b that connect the antenna device 31 to the control section 33, as shown in FIG. 5. The choke coils 61 prevent inflow of a high-frequency signal from the quarter-wave line 51 to the control section 33. Therefore, the high-frequency signal radiated from the sleeve antenna 43 does not adversely affect the control section 33. The choke coil 61 may also be provided solely in the wire 57a connected to the control section 33.

In the present embodiment, FIGS. 3 and 4 illustrate an example in which one antenna device 31 is provided on one substrate 41, but a plurality of antenna devices may also be provided on a single substrate. Moreover, in the present embodiment, an explanation has been given by taking the half-wave dipole antenna as an example of the passive elements 45a and 45b, but a half-wave monopole antenna may also be used. In this case, the PIN diode and the capacitor are connected to at either end of the monopole antenna. Further, in the present embodiment, the antenna device 31 has the two passive elements 45a and 45b, but one passive element may also be acceptable.

As mentioned above, the client terminal 14 of the IFE system has the three antenna devices 31 of the present embodiment capable of switching their directivities by electrical operation; hence, the client terminal 14 can perform superior communication of stable quality during wireless communication utilizing the MIMO scheme in a radio wave environment where there are many reflected waves.

In the embodiment, the antenna device 31 has the sleeve antenna 43 and the passive elements 45a and 45b, but a dipole antenna may also be used in place of the sleeve antenna 43.

Although the present invention has been described in detail by reference to a specific embodiment, it is manifest to those skilled in the art that the present invention be susceptible to various alterations or modifications within the spirit and scope of the present invention.

The present patent application is based on Japanese Patent Application (JP-2006-287791) filed on Oct. 23, 2006, the contents of which are incorporated herein for reference.

### INDUSTRIAL APPLICABILITY

An antenna device of the present invention is useful as a compact antenna device, or the like, capable of switching its directivity by means of electrical operation.

1. An antenna device comprising:
a linear antenna element;
a passive element section provided in proximity to the antenna element; and
a control section that controls the passive element section,
wherein the passive element section includes:
a linear line arranged in parallel to the antenna element; and
an impedance adjustment section that adjusts impedance of the passive element section.

2. The antenna device according to claim 1, wherein the impedance adjustment section is a diode electrically connected to the linear line.

3. The antenna device according to claim 2, wherein the passive element section is a dipole element in which two quarter-wave lines are arranged in a straight line; and
wherein the impedance adjustment section is a diode disposed at a center of the dipole element.

4. The antenna device according to claim 1, wherein the antenna element and the passive element section are provided in parallel to each other; and
wherein an electrical length from an end of the antenna element to the passive element section is a quarter wavelength.

5. The antenna device according to claim 1, wherein the passive element sections are respectively provided at both ends of the antenna element.

6. The antenna device according to claim 1, wherein the control section outputs a control signal for controlling the impedance adjustment section.

7. The antenna device according to claim 1, further comprising:
two inductor sections, one being provided in a wire connecting the passive element section to the control section, and the other being provided in a wire connecting the passive element section to a ground.

8. The antenna device according to claim 1, wherein the antenna element is a sleeve antenna or a dipole antenna.
